(19) United States
(12) Patent Application Publication
(10) Pub. No.: US 2025/0366447 A1
(43) Pub. Date: Dec. 4, 2025

(54) Aquaculture Platform

(71) Applicant: CAKEBOXX TECHNOLOGIES, LLC, McLean, VA (US)

(72) Inventor: Daine Edward Eisold, McLean, VA (US)

(73) Assignee: CAKEBOXX TECHNOLOGIES, LLC, McLean, VA (US)

(21) Appl. No.: 18/875,937

(22) PCT Filed: Jun. 27, 2023
(86) PCT No.: PCT/US2023/026322

§ 371 Date: Dec. 17, 2024

Related U.S. Application Data
(60) Provisional application No. 63/355,806, filed on Jun. 27, 2022.

(51) Int. Cl. A01K 63/00

(52) U.S. Cl. CPC A01K 63/003

(57) ABSTRACT

Provided herein is an aquaculture platform which comprises a set of divisions, sections, channels, drainpipes and specialized climate sensors. The platform is designed to be hauled by sea, road, rail, and air transportation systems while minimizing the need to remove or reconfigure the cargo during multimodal and intermodal transport.

The Aquaculture Platform is designed with the intention of recreating a fast-paced environment to meet the requirements for marine life farming (shrimp, tilapia, oysters, etc), in a modular and quickly scalable manner. Through a set of divisions, sections, channels, drainpipes and specialized climate sensors, the platform can guarantee marine life growth, and at the same time, mitigate cross-contamination risks between production batches. The platform is designed to be hauled by sea, road, rail, and air transportation systems while minimizing the need to remove or reconfigure the cargo during multimodal and intermodal transport.

The platform uses the same key features used in transportation, such as corner castings and twist-locks devices, to support itself, and up to 8-high stacked platforms, which will allow for different growing stages, from incipient forms to commercially grade size. The result is a complete batch for geometrical grown marine species, significantly reducing the area required in other similar marine life farming practices.

The purpose of using this platform is the possibility to quickly farm in a modular and scalable way for different marine life. The design of a marine life supporting platform uses some key properties, like stickability, robustness, as well as the use of standard locking devices, used in the shipping container industry. Using the specific design on each platform, it will create a growing path with a combination of directional water jets, elliptical path to recreate the appropriate growing conditions for a specific period, depending on the life form geometrical growth factor. Customized sensors may be installed in the platform to provide control and alert sensible ecosystem metrics, such as temperature, pH, salinity, water turbidity, among others. In this way, the platform provides structural safety and soundness on each growing stage.

The stackable model on the platform responds to the best usage of available space, while factorizing the production batches, reducing cross contamination as well as mitigating production losses, by establishing physical barriers between stages. To set up one platform, it will require external plumbing, electrical, and control systems in the most suitable and available way. The main drainpipe will be used to remove its current content to the subsequent stage. Stacking up to 8-high platforms, it optimizes piping, utilities, and control installations, creating a much more controlled life development, and multiplies the potential production factor for sustainable marine farming.

### BRIEF DESCRIPTION OF THE DRAWINGS

FIG. 1 is a perspective view of the Aquaculture Platform.

FIG. 2 is a perspective view of the Aquaculture Platform showing drain.

FIG. 3 is a top view of the Aquaculture Platform.

FIG. 4 is an internal transversal view of the Aquaculture Platform.

FIG. 5 is a side view of the Aquaculture Platform.

FIG. 6 is an end view of the Aquaculture Platform.

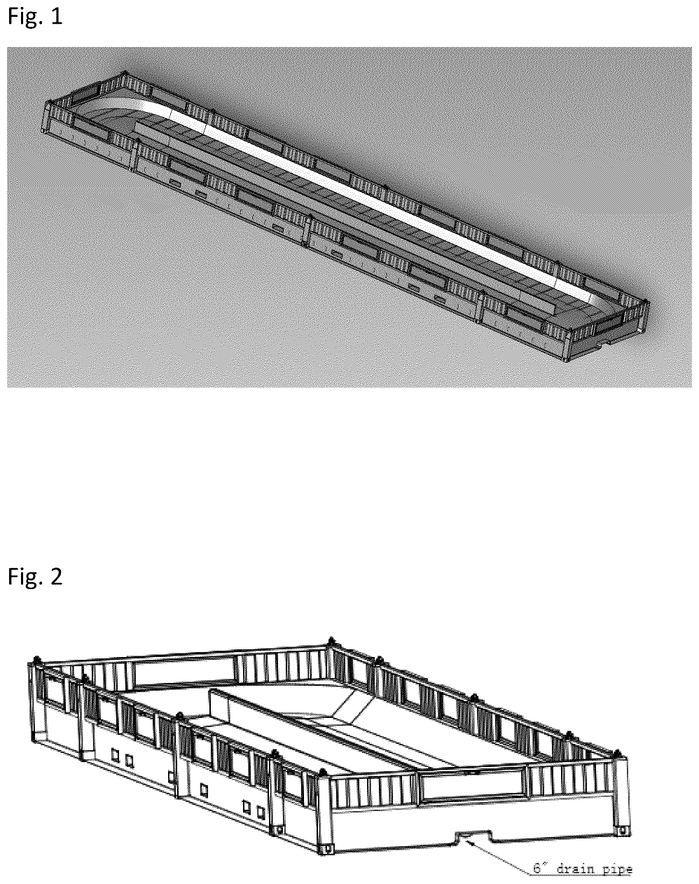

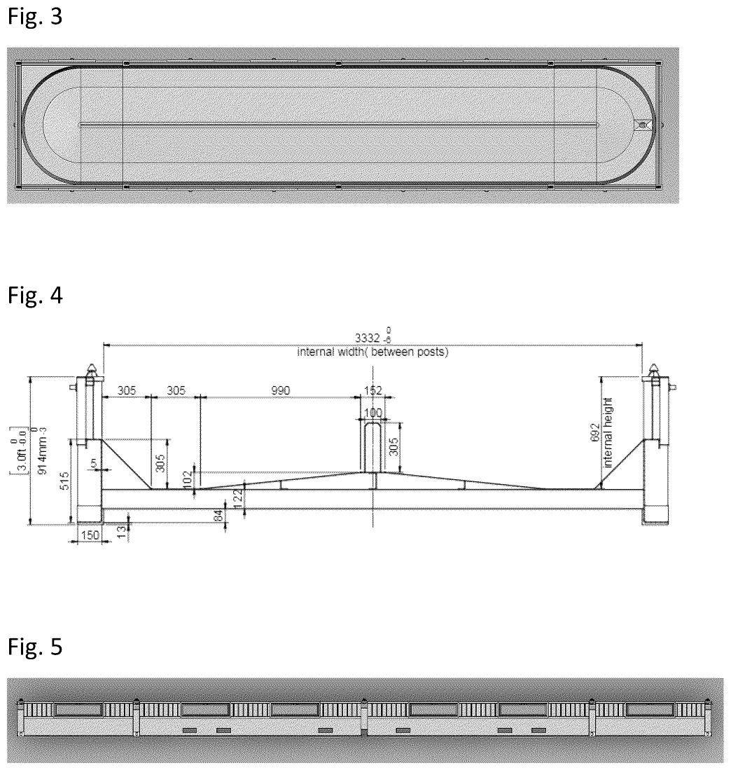

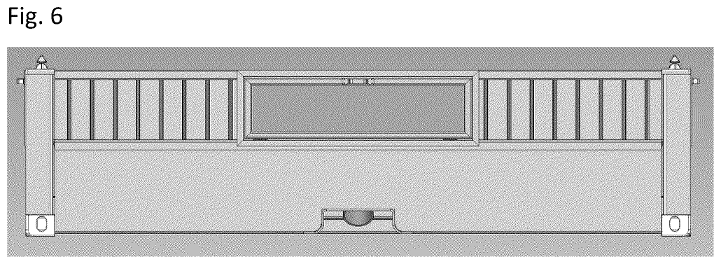

### DETAILED DESCRIPTION

Upon review of the description and embodiments of the present invention, those skilled in the art will understand that modifications and equivalent substitutions may be performed in carrying out the invention without departing from the essence of the invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. Thus, the invention is not meant to be limiting by the embodiments described explicitly above, and is limited only by the claims which follow. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

### Manufacturing

The platform may be made of any suitable material; in an exemplary embodiment the platform is constructed from steel. When steel is used to fabricate the platform, steelwork may advantageously be built up by means of automatic and semi-automatic CO₂ gas arc welding (MAG welding). The internal bend radius of the pressed section of the steel is not less than 1.5 times the thickness of the material being pressed.

The platform is constructed with a base consisting of at least four up to ten or more ISO casting corner fittings, U-shaped longitudinal rails, high strength steel walls, plexiglass windows and no roof. The height of the walls may be varied as needed for the particular application; in an exemplary embodiment the walls may be 2′ 3 ¼″ high. All external dimensions will be determined based on the requirements for the particular aquaculture, availability of the physical space and utilities, as well as for the biomass farming space requirements and grow rate. In an exemplary embodiment, the platform has an external dimension of sixty (60) feet long, twelve (12) feet wide, and three (3) feet height, but can be adjusted based on requirements.

Standard steel corner castings comply with ISO-1161 standard and are weldable. Casting plates may be configured with twist-locks permanently mounted to the top of each post.

The platform frame has two side U-shaped rails, one or more U-shaped cross beams, which may be fabricated from high strength steel, two end sills, up to fourteen rectangular shaped plexiglass windows and corrugated steel plates as walls, arranged according to design, lashing rings, and three (3) sets of forklifts pockets. The base floor can be made in a combination of epoxy coated steel, fiberglass, composite materials, or a combination thereof.

The design of the platform has a plate with a central beam conformed by double U-shaped beam that creates a longitudinal aisle, U-shaped and L-shaped beams that will support and create a small inclination from center towards both sides, thereby creating a natural flow of liquids, welded, and arranged in a way that is completely watertight. At one end there is a drainpipe; the size of the drainpipe may be adjusted as necessary; in one embodiment the drainpipe will be 6″ in diameter. Each side wall also creates a steep slope towards the center of the pool. This base arranged creates a W-shaped cross-section view of the platform. This will create a natural flow for the channel, avoiding the biomass to stagnate. At each end side the base plate may be conformed in a semi-circular shape to fully enclosed the pool. The depth of the pool may be varied as needed to optimize the environment in the platform; in an exemplary embodiment the depth of the pool varies from about 8″ to about 1′.

Special mention and treatment to the underneath side of the stacked platforms, which may replicate the upper side on the platform beneath. A coating may be added on either or both of the internal and external sides of the platform, so it can withstand corrosion due to use of salted water, warm temperatures, biomass, and fecal material. In an exemplary embodiment the coating may comprise epoxy resin.

Where the platform is fabricated from welded steel, once the welding work is done, there will be a process to remove all the slag and spatters. The contaminated area will then be cleaned and degreased before pickling. The purpose of the pickling process is to completely remove the rust or mill scale and some other attachment on the surface. Finally, the platform may be coated with a sea-water resistant coating, which may comprise epoxy resin.

Each side rail may comprise one or more rectangular openings, which may be used as forklift pockets or for jack legs. The number, position, and size of the openings will be determined by their intended use. For example, forklift pockets will typically be positioned near the middle of the side rails, while openings for jack legs will typically be positioned near the ends of the side rails. The openings may align with the cross beams to allow insert lifting beams to go through to hold this platform at a certain height that the jacks lift it to, while protecting the integrity of the structure beneath the pool. Each lift pocket may be created with two U-shaped cross beams facing each other, being enclosed by a rectangular shape tube, creating a rectangular shape that will guide the forks or passing thru beams for lifting purposes.

For use as forklift pockets the openings will be present in pairs; up to three sets of forklift pockets per side may be used. The purpose for the forklift pockets are for empty lifting only. Without any biomass cargo on it, the central forklift pockets are for single platform empty only lifting. A bundle of these platforms can be lifted with two forklift trucks through the two sets of forklift pockets at the outside.

Cross beams may be used to connect the side rails; in an exemplary embodiment, up to 31 cross beams are employed. The end sills may be welded “I” beams with U-shaped notches at the top centers with top flanges and bottom flanges.

Once the platforms are stacked and assembled, with the exception of the one at the top, they will create a self-containing environment that will reduce the risk of external or cross contamination.

Customized sensors may be installed in the platform to provide control and alert sensible ecosystem metrics, such as temperature, pH, salinity, water turbidity, among others.

### Transportation:

The platform may be loaded at an off-site location such a factory, or a work site then easily loaded directly onto an ocean vessel deck, breakbulk ship, rail car or trailer for special transport to destination, due to extended dimensions. Once loaded and secured to the transportation chassis or trailer the cargo can be safely transported from origin to destination, and moved from one type of transportation to another, such as from truck to rail to ocean vessel with special requirement to handle oversized cargo.

The platform bundle chassis structure is constructed using standardized ISO 1161 style corner castings and will have oversized dimensions that will require special handling requirements to enable it to fit and be compatible with existing shipping container-based transportation systems.

Empty, unloaded platforms can be bundled horizontally using twist-lock style inter-box connectors (IBCs) and can be shipped and stored in the bundled configuration. Once deployed and installed in the factory, the design of the platform will be capable of self-stacking 8 high at max gross on condition that all the bottom fittings are all properly supported on the ground.

On the supporting chassis the new platform is suitable for road and rail transportation, including but not limited to flat bed or skeletal chassis, designed for oversized dimensions, secured at the four bottom corner fittings.

The platform is capable of being handled without any permanent deformation that will render it unsuitable for use or any other abnormality, with the following restrictions:
a. Lifting, empty only, at the bottom corner fittings using slings with appropriate terminal fittings at slings angle of forty-five degrees to horizontal.
b. Lifting, empty only, at the hooks using slings with appropriate terminal fittings at slings angle of forty-five degrees to horizontal.
c. Lifting, empty only, from forklift pockets in center, or two forklifts simultaneously on side pockets.
d. Lifting hooks lift a concentrated load on two evenly distributed areas when lifting from hooks at 45 degrees to horizontal.

What is claimed is:

1. An aquaculture platform comprising
two side rails;
two end sills;
wall plates attached to the side rails and end sills;
transparent windows disposed within the wall plates;
one or more cross beams connecting the side rails;
a floor plate disposed on the cross beams and secured to the wall plates to form a watertight seal, wherein the floor plate forms a “W” shape in cross-section;
a central beam disposed on the floor plate to create a longitudinal aisle; and
a drain pipe disposed at one end of the platform.

2. The platform of claim 1, wherein the platform is fabricated from steel.

3. The platform of claim 1, further comprising at least four ISO casting corner fittings.

4. The platform of claim 1, wherein the windows are plexiglass.

5. The platform of claim 1, wherein the platform comprises high strength steel.

6. The platform of claim 1, further comprising standard steel corner castings with twist-locks permanently mounted to the top of each post.

7. The platform of claim 1, further comprising up to three pairs of forklift pockets.

8. The platform of claim 7, wherein the forklift pockets are aligned with cross beams.

8. The platform of claim 1, wherein the floor plate comprises epoxy coated steel, fiberglass, composite materials, or a combination thereof.

9. The platform of claim 1, wherein each side wall creates a slope towards the center of the pool, such that the base has a W-shaped cross-section.

10. The platform of claim 1, wherein the base plate is conformed in a semi-circular shape to fully enclosed the pool.

11. The platform of claim 1, further comprising a corrosion-resistant coating.

12. The platform of claim 11, wherein the coating comprises epoxy resin.

13. The platform of claim 1, further comprising rectangular openings in the side rails into which jack legs may be inserted.

14. The platform of claim 1, further comprising one or more sensors.

15. The platform of claim 1, wherein the sensors detect water temperature, pH, salinity, and/or turbidity.
